(19) United States
(12) Patent Application Publication
(10) Pub. No.: US 2014/0070648 A1
(43) Pub. Date: Mar. 13, 2014

(54) THRUST WASHER FOR AN ELECTRIC MACHINE

(71) Applicant: Wolfgang Winkler, Schutterwald (DE)

(72) Inventor: Wolfgang Winkler, Schutterwald (DE)

(73) Assignee: ROBERT BOSCH GMBH, Stuttgart (DE)

(21) Appl. No.: 14/118,497

(22) PCT Filed: Mar. 20, 2012
(86) PCT No.: PCT/EP2012/054903

§ 371 Date: Nov. 18, 2013

(30) Foreign Application Priority Data
May 18, 2011 (DE) 10 2011 076 079.2
Dec. 29, 2011 (DE) 10 2011 090 062.4

(51) Int. Cl. F16C 17/04; H02K 5/16

(52) U.S. Cl. CPC F16C 17/04; H02K 5/161
USPC 310/90; 384/138

(57) ABSTRACT

The invention relates to a thrust washer (28) for an electric machine (10, 12) intended to be arranged on a shaft (16) between a bearing (18) and a rotor (14), preferably a rotating electrical contact element (24) impacted by brushes (38), and/or a lamination stack (36) of the rotor (14). The thrust washer (28) is provided with an area for sealing having two end faces (32, 34). Each end face (32, 34) has at least one abutment section (50, 52) for the bearing (18) or the rotor (14). A cavity (54) that is circumferential in at least some sections is arranged between the abutment sections (50, 52) of the two end faces (32, 34).

### BACKGROUND OF THE INVENTION

The invention is based on a thrust washer for an electric machine which is intended to be arranged on a shaft between a bearing and a rotor, wherein the thrust washer has a region for providing sealing having two end faces and has at least one abutment section for the bearing and, respectively, the rotor on each end face. A thrust washer of this kind for an electric machine can be arranged on a shaft between a bearing and a rotor, in particular a rotating electrical contact element which is acted on by brushes and/or a laminate stack of the rotor. The thrust washer has a region for providing sealing having two end faces and has at least one abutment section for the bearing and, respectively, the rotor on each end face.

Electric motors such as those generally used for heating and air-conditioning motors are required to fulfill stringent requirements with regard to noise. The noise level is greatly influenced by the so-called longitudinal oscillation of the armature which is excited by means of the longitudinal play of generally a few tenths of a millimeter which occurs in the electric motor during operation. The electric motor contains so-called thrust washers which are arranged between the stationary sliding, ball or roller bearings and the rotating armature or rotor and reduce the friction by virtue of their material characteristics—such as wear resistance, surface, service life etc. On account of likewise stringent requirements in respect of service life, that is to say wear resistance, the material—generally an elastic plastic, for example polyester elastomer—has a low level of intrinsic elasticity. It is also known to install corrugated washers or corrugated rings. However, said corrugated washers and corrugated rings only function when there is contact between the stationary and rotating parts.

It is possible by means of skillful selection of the elasticity and damping of the thrust washer to modify the excitation of the axial oscillation to such an extent that said axial oscillation is damped during operation and thus does not produce any noise. DE 10 2004 044 340 A1 discloses, for example, a thrust washer of the type mentioned above for an electric machine, in which the abutment sections of the two end faces are connected to one another by means of resilient sections which are formed on the thrust washer.

### SUMMARY OF THE INVENTION

The object of the invention is to provide a thrust washer for an electric machine which further improves the damping of the longitudinal oscillation of the armature in comparison to existing thrust washers in conjunction with a reduction in costs and further reduces the production of noise.

The thrust washer according to the invention for an electric machine has the advantage that the damping of the longitudinal oscillation of the armature can be improved in conjunction with a reduction in the production of noise without using additional parts (for example corrugated rings). In addition, the wear resistance is increased and the machine construction is simple. To this end, a hollow space which is circumferential at least in sections is arranged in an inventive manner between the abutment sections of the two end faces. This hollow space constitutes the damping element and, on account of its elasticity, changes the stiffness of the thrust washer in the region of the abutment section, as a result of which the damping of the longitudinal oscillation of the armature can in turn be improved in conjunction with a reduction in the production of noise without using additional parts (for example corrugated rings).

In order to be able to further influence the damping characteristic of the thrust washer, provision is made for the hollow space to run over the entire circumference of the abutment sections. In this case, the hollow space is preferably of closed design, while its cross section can change over the circumference or in sections. In addition, it is possible to provide supporting elements, for example in the form of supporting webs, in the hollow space or the hollow space sections, depending on the desired damping characteristic and/or depending on any resonances of the longitudinal oscillations of the armature.

In order to save costs during production, the thrust washer is advantageously composed of a single material. In this case, a possible production method is, in particular, the fluid injection technique. As an alternative, it is also possible to assemble the thrust washer from two parts in the region of the hollow space, preferably in the axial direction centrally through the hollow space. In this case, adhesive bonding, welding or lasering can be used to connect the two individual parts.

### BRIEF DESCRIPTION OF THE DRAWINGS

The invention will be explained by way of example below with reference to FIGS. 1 and 2, wherein similar reference numerals in the figures indicate similar constituent parts which have a similar manner of operation. The figures in the drawing, the description of the figures and the claims contain numerous features in combination. A person skilled in the art will also consider these features individually and combine said features to form further expedient combinations. In particular, a person skilled in the art will also combine the features of different exemplary embodiments to form further expedient combinations.

In the drawing:

FIG. 1: shows a longitudinal section through an electric machine,

FIG. 2: shows a cross section through a first embodiment of the thrust washer according to the invention, and

FIG. 3: shows different cross sections (FIG. 3a, FIG. 3b) through a further embodiment of the thrust washer according to the invention.

### DETAILED DESCRIPTION

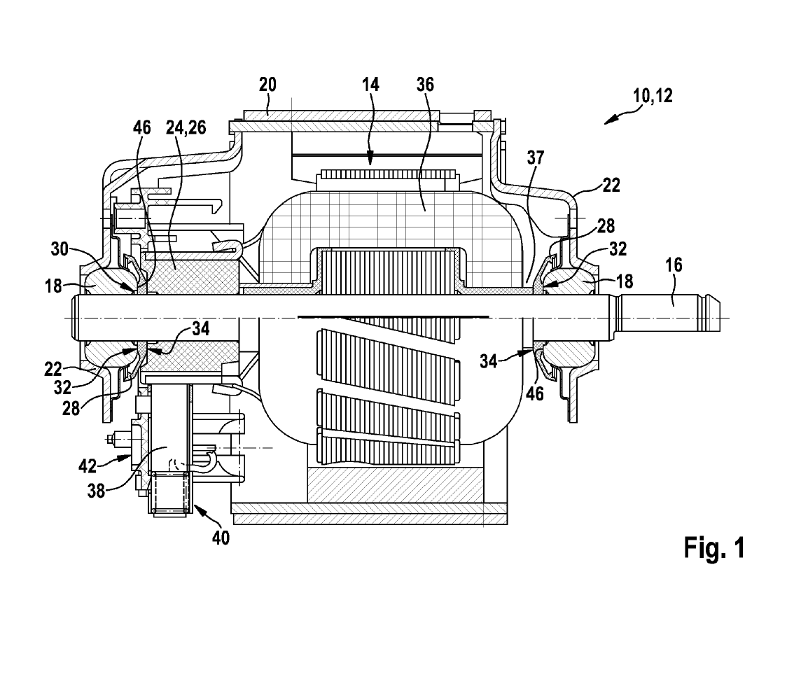

A part of a rotating electric machine 10 is illustrated in a simplified manner in longitudinal section in FIG. 1. The electric machine 10 is an electric motor 12 which is used in a motor vehicle, for example in a window lifter, a wiper drive, preferably a heater and blower drive etc. However, it can also be a generator.

The electric motor 12 has a wound rotor 14 which is arranged on a shaft 16. The shaft 16 is mounted using two bearings 18. In the present exemplary embodiment, the bearings 18 are sintered cup and ball bearings or sliding bearings which are saturated with oil. However, other bearings 18, such as ball bearings, roller bearings or the like, can also be used. The bearings 18 are in each case arranged in end plates 22 which are located on the two end faces of a housing 20 of the electric motor 12.

A thrust washer 28 having a receiving bore 30 for the shaft 16 is arranged on the shaft 16 between one of the bearings 18 and a commutator 26 which is used as an electrical contact element 24. The thrust washer 28 preferably bears against the bearing 18 by way of its first end face 32 and against the commutator 26 by way of its second end face 34. The thrust washer 28 preferably has a press-fit on the shaft 16. The press-fit provides sealing against vagabonding lubricant of the bearing 18 on the shaft 16. A further thrust washer 28 is arranged between the other bearing 18 and the rotor 14 or a laminate stack 36 or the collar 37 of an insulating laminate of the laminate stack 36. However, this further thrust washer can also be dispensed with or a differently formed thrust washer can be provided. The rotor is supported in the axial direction of the shaft 16 on the bearings 18 by means of the one thrust washer or the two thrust washers 28.

Instead of the commutator 26, it is also possible to provide a collector of a generator as the electrical contact element 24. In both cases, electrical contact is made with the electrical contact element 24 by means of brushes 38 which are guided in brush cartridges 40, wherein the brush cartridges 40 are fastened to a brush carrier 42 of the electric machine 10 by means of fastening lugs. In addition, it is also feasible to use the thrust washer 28 according to the invention in a brushless or electrically commutated motor, wherein the sealing function of the thrust washer 28 may then play a secondary role. However, the term “sealing region” should still be used in this case for reasons of clarity.

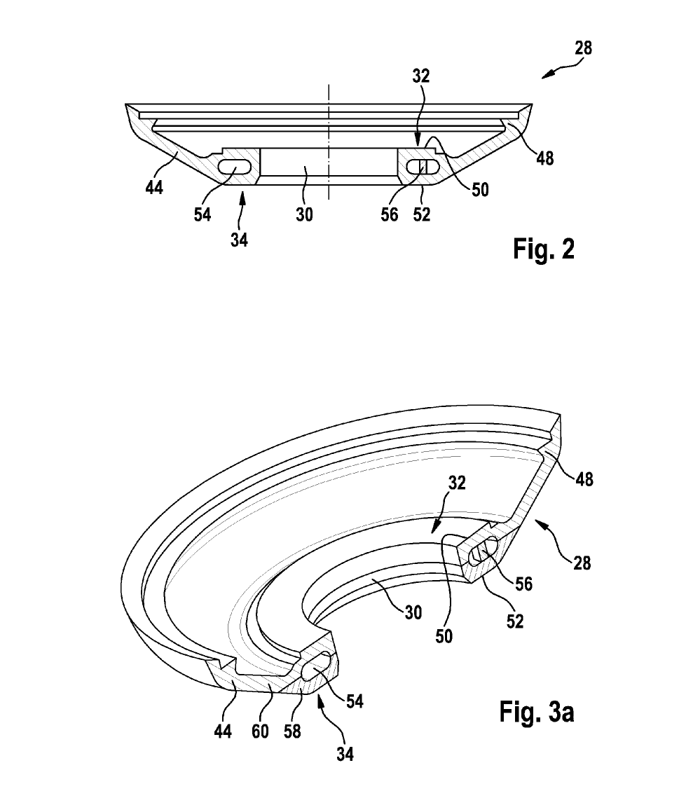

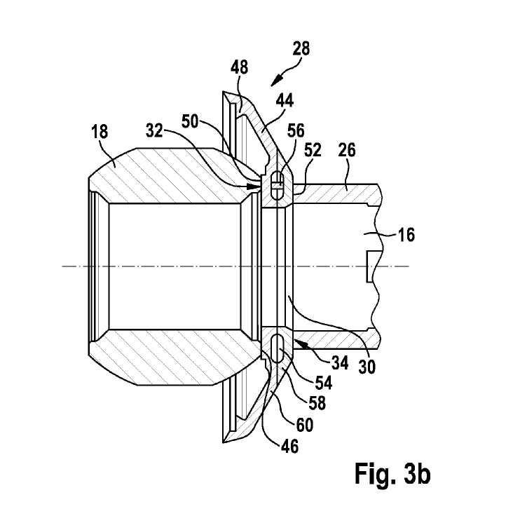

FIG. 2 shows the thrust washer 28 on an enlarged scale. Said thrust washer has a conically tapering region 44 for returning lubricant to the bearing 18. For this purpose, the thrust washer 28 extends in the manner of a hood over that end face 46 of the bearing 18 (see, in particular, FIGS. 1 and 3b) which faces said thrust washer. Said thrust washer has a circumferential, inwardly directed projection 48 on the curved, outer rim. As a result, lubricant, such as oil for example, can be returned to the bearing 18 again. As an alternative, the conically tapering region 44 can also be of curved design in order to influence the return flow of the oil. However, in conjunction with a brushed electric motor or generator, it is essential that a sealing region for ensuring electrical contact is made with the commutator or collector is provided.

An abutment section 50 for the bearing 18 is formed on the first end face 32, and an abutment section 52 for the rotor 14 is formed on the second end face 34. The rotor 14 or armature can bear directly against the abutment section 52 or by means of the commutator 26. The abutment sections 50 and 52 are of annular design.

According to the invention, provision is now made for a hollow space 54 which is circumferential at least in sections and is preferably closed to be arranged between the abutment sections 50, 52 of the two end faces 32, 34. In this case, the thrust washer 28 is composed of a single material and is preferably produced using a fluid injection technique. A fluid injection technique is understood in the plastics-processing industry as a special injection-molding method which is based on the gas injection technique. The differences lie substantially in the injection medium used. Said injection medium can be gas (usually nitrogen) or water or both. The hollow space 54 serves as a damping element and influences the stiffness of the thrust washer 28 in the region between the two abutment sections 50, 52. Said hollow space changes the structure of the thrust washer 28 in such a way that it is used to generate an elastic region which counteracts the longitudinal oscillation of the armature during operation on account of its changed stiffness and damping behavior and prevents corresponding production of noise due to its spring damping.

The damping characteristic can be further influenced by the arrangement and/or the shape of the hollow space. Therefore, it is possible to form the hollow space in a circumferential manner not only in sections but also completely. Similarly, the cross section of the hollow space can be varied in respect of its form and its size in sections or over the entire circumference. Therefore, instead of a partially oval hollow space cross section as illustrated in the figures, it is also possible, for example, to select an oval, circular or polygonal cross section. Furthermore, it is possible to arrange supporting elements 56 in the hollow space, said supporting elements having a partial influence on the stiffness. The supporting elements 56 can be designed in the form of axial webs and be distributed over the circumference of the hollow space 54 or of the hollow space sections in an equidistant manner or in defined positions so as to match a specific resonance behavior.

FIGS. 3a and 3b show a further embodiment of the thrust washer 28. In contrast to FIG. 2, said thrust washer is now composed of two parts 58 and 60 which are assembled in the axial direction of the shaft 16 centrally through the hollow space 54. However, it is likewise also feasible to axially assemble the two parts 58 and 60 outside the hollow space 54, that is to say in the immediate vicinity of said hollow space. The two parts 58 and 60 may be adhesively bonded, welded or lasered in this case.

Finally, it should be noted that the exemplary embodiment shown is not limited to FIGS. 1 to 3 but rather that forms of application and arrangements which differ therefrom are also feasible within the electric machine 10. In addition, the dimensional ratios shown in the figures between the thrust washers 28 according to the invention and the remaining components of the electric machine 10, in particular the bearings 18 and the rotor 14, do not as such have any influence on the invention. The same applies for the shape and size of the supporting elements 56 within the hollow space 54.

1. A thrust washer (28) for an electric machine (10, 12), the thrust washer configured to be arranged on a shaft (16) between a bearing (18) and a rotor (14), wherein the thrust washer (28) has a region for providing sealing having two end faces (32, 34) and has at least one abutment section (50, 52) for the bearing (18) and, respectively, the rotor (14) on each end face (32, 34), characterized in that a hollow space (54) which is circumferential at least in sections is arranged between the abutment sections (50, 52) of the two end faces (32, 34).

2. The thrust washer (28) as claimed in claim 1, characterized in that the rotor (14) has a rotating electrical contact element (24) which is acted on by brushes (38).

3. The thrust washer (28) as claimed in claim 1, characterized in that the hollow space (54) is of closed design.

4. The thrust washer (28) as claimed in claim 1, characterized in that the hollow space (54) is formed over an entire circumference of the abutment sections (50, 52).

5. The thrust washer (28) as claimed in claim 1, characterized in that the hollow space (54) has different cross section over a circumference of the space.

6. The thrust washer (28) as claimed in claim 1, characterized in that the thrust washer (28) is composed of a single material.

7. The thrust washer (28) as claimed in claim 1, characterized in that the thrust washer (28) is produced using a fluid injection technique.

8. The thrust washer (28) as claimed in claim 1, characterized in that the thrust washer (28) is assembled from two parts (58, 60) in the region of the hollow space (54).

9. The thrust washer (28) as claimed in claim 8, characterized in that the two parts (58, 60) are connected to one another by adhesive bonding, welding or lasering.

10. (canceled)

11. The thrust washer (28) as claimed in claim 1, characterized in that the hollow space (54) has oval, circular or polygonal cross sections, over a circumference of the space.

12. The thrust washer (28) as claimed in claim 1, characterized in that the hollow space (54) is provided with supporting elements (56).

13. The thrust washer (28) as claimed in claim 1, characterized in that the thrust washer (28) is assembled from two parts (58, 60) in an axial direction centrally through the hollow space (54).

14. An electric machine (10, 12) comprising a shaft (16) between a bearing (18) and a rotor (14), and a thrust washer (28) including a region for providing sealing having two end faces (32, 34), and at least one abutment section (50, 52) for the bearing (18) and, respectively, the rotor (14) on each end face (32, 34), characterized in that a hollow space (54) which is circumferential at least in sections is arranged between the abutment sections (50, 52) of the two end faces (32, 34).

15. The electric machine as claimed in claim 14, characterized in that the rotor (14) has a rotating electrical contact element (24) which is acted on by brushes (38).

16. The electric machine as claimed in claim 14, characterized in that the hollow space (54) is of closed design.

17. The electric machine as claimed in claim 14, characterized in that the hollow space (54) is formed over an entire circumference of the abutment sections (50, 52).

18. The electric machine as claimed in claim 14, characterized in that the hollow space (54) has different cross sections over a circumference of the space.

19. The electric machine as claimed in claim 14, characterized in that the thrust washer is composed of a single material.

20. The electric machine as claimed in claim 14, characterized in that the thrust washer is produced using a fluid injection technique.

22. The electric machine as claimed in claim 14, characterized in that the thrust washer is assembled from two parts (58, 60) in the region of the hollow space (54).

23. The electric machine as claimed in claim 22, characterized in that the two parts (58, 60) are connected to one another by adhesive bonding, welding or lasering.

24. The electric machine as claimed in claim 14, characterized in that the rotor (14) has a rotating electrical contact element (24) which is acted on by brushes (38).

25. The electric machine as claimed in claim 14, characterized in that the hollow space (54) has oval, circular or polygonal cross sections, over a circumference of the space.

26. The electric machine as claimed in claim 14, characterized in that the hollow space (54) is provided with supporting elements (56).

27. The electric machine as claimed in claim 14, characterized in that the thrust washer (28) is assembled from two parts (58, 60) in an axial direction centrally through the hollow space (54).
